(19) United States
(12) Patent Application Publication
(10) Pub. No.: US 2014/0328992 A1
(43) Pub. Date: Nov. 6, 2014

(54) TOOTH-FRIENDLY SUGAR CONFECTIONERY

(71) Applicant: GELITA AG, Eberbach (DE)

(72) Inventors: Birgit GUILLEAUME, Spechbach (DE); Stephan HAUSMANNS, Heidelberg (DE); Elvira LANG, Heilbronn (DE); Annelore SCHOTT, Heidelberg (DE)

(21) Appl. No.: 14/335,201

(22) Filed: Jul. 18, 2014

Related U.S. Application Data
(63) Continuation of application No. PCT/EP2013/051075, filed on Jan. 22, 2013.

(30) Foreign Application Priority Data
Jan. 27, 2012 (DE) 10 2012 100 691.1
Mar. 23, 2012 (DE) 10 2012 102 502.9

(51) Int. Cl. A23G 3/44; A23G 3/42

(52) U.S. Cl. CPC A23G 3/44; A23G 3/42
USPC 426/548; 426/576

(57) ABSTRACT

The present invention relates to a tooth-friendly sugar confectionery based on a gelatin gel, which includes approximately 1 to approximately 15 weight % of gelatin, wherein the sugar confectionery includes trehalose and a resistant dextrin.

### CROSS-REFERENCE TO RELATED APPLICATIONS

This patent application is a continuation of International Application Number PCT/EP2013/051075, filed Jan. 22, 2013, which claims the benefit of German applications DE 10 2012 100 691.1, filed Jan. 27, 2012, and DE 10 2012 102 502.9, filed Mar. 23, 2012, which are each incorporated by reference.

### BACKGROUND OF THE INVENTION

The present invention relates to a tooth-friendly sugar confectionery based on a gelatin gel, which includes approximately 1 to approximately 15 weight % of gelatin.

Conventional sugar confectionery based on a gelatin gel, such as gumdrops or jelly bears, includes, in addition to gelatin, considerable quantities of sugar, that is in particular sucrose as well as glucose, fructose and/or glucose syrup. It has long been known that, at least if such confectionery is consumed regularly, these mono- and disaccharides encourage the development of caries, since they break down into acids (especially lactic acid, acetic acid and propionic acid) in the bacterial plaque on the teeth, and these acids attack the dental enamel.

For this reason, for some while attempts have been made to provide foodstuffs and luxury foods which are tooth-friendly, or safe for teeth, and which either contain absolutely no constituents which can be metabolised by the microorganisms in the dental plaque, or which contain them in such small quantities that there is no cariogenic effect. Sugar substitutes which are known in this context are sugar alcohols, which also taste sweet, such as sorbitol, xylitol and maltitol, which are already used in products such as tooth-friendly chewing gums and hard caramels. However, beyond a certain content these sugar alcohols have a laxative (purgative) effect, with the result that their use in sugar confectionery, which may well be eaten in relatively large quantities (e.g. 100 g or more), is extremely problematic. In particular children often have a sensitive reaction in this regard. Moreover, products which contain such laxative substances in a quantity greater than 10 weight % have to be labelled as such.

A further restriction results from the fact that the sugars that are usually present in sugar confectionery based on a gelatin gel are not only responsible for the sweet taste but also for the consistency and texture of the products. Replacing the sugar with other substances frequently results in changes in this regard that are rejected by consumers (e.g. sticking to the teeth, or too short a bite).

An additional point is that the manufacturing process of sugar confectionery of this kind is also optimised to recipes containing sugar, and replacing the sugar, for example by sugar alcohols, typically results in problems in the moulding process, since the viscosity of the moulding solution increases.

### BRIEF SUMMARY OF THE INVENTION

The object of the invention is therefore to propose a tooth-friendly sugar confectionery based on a gelatin gel which has no laxative effect and can readily be processed in the context of the manufacturing method known for sugar confectionery.

This object is achieved according to the invention in the case of the sugar confectionery of the type mentioned at the outset, in that the sugar confectionery includes trehalose and a resistant dextrin.

Surprisingly, it has been found that, using a combination of trehalose and a resistant dextrin, a tooth-friendly sugar confectionery can be obtained which entirely meets the requirements mentioned above.

### DETAILED DESCRIPTION OF THE INVENTION

Trehalose is a disaccharide in which two glucose units are linked by a 1,1-glycoside bond. This bond cannot be broken by the microorganisms in the bacterial dental plaque (in particular Streptococcus mutans), or can be broken only to a limited extent, with the result that trehalose demonstrably has no cariogenic effect (see for example T. Netta et al., Journal of Dentistry 28 (2000) 571-576). Furthermore, trehalose has no laxative effect either.

Favourably, the proportion of trehalose in the sugar confectionery according to the invention is in the range of up to approximately 30 weight %, preferably in the range of approximately 10 to approximately 27 weight %. The proportion of trehalose can be varied within this range depending on the desired sweetness of the product. Moreover, it has been shown that at least up to a proportion of approximately 30 weight %, the composition has a viscosity suitable for the moulding procedure.

Up to a trehalose content of approximately 14 weight %, there is no crystallisation of the trehalose, even after relatively long storage of the sugar confectionery. Crystallisation of the sugar constituents is avoided in most known sugar confectionery based on gelatin (such as jelly bears). It results in a change in the texture which is rejected by many consumers who are familiar with these products. However, there are also gumdrops with partly crystallised sugar, such as the jelly babies which are common in Great Britain. For the manufacture of such products, the proportion of trehalose in the sugar confectionery according to the invention may also be more than approximately 14 weight %.

Favourably, besides trehalose, the tooth-friendly sugar confectionery includes as small as possible a proportion of mono- or disaccharides, in particular less than approximately 10 weight %. It is particularly preferable if the sugar confectionery includes no further mono- or disaccharides other than trehalose which could bring the tooth-friendly properties of the sugar confectionery into question.

The proportion of resistant dextrin which, as well as trehalose, is present in the sugar confectionery according to the invention is preferably in the range of up to approximately 30 weight %, more preferably in the range from approximately 10 to approximately 26 weight %. Above a proportion of approximately 30 weight %, during heating in the course of the manufacturing method, caramelisation may occur, as well as a high level of tackiness. This tackiness has an adverse effect on both the handling of the sugar confectionery (sticking to one another and to the packaging) and its texture (unpleasant sticking to the teeth).

Resistant dextrins are oligosaccharides based on glucose units which cannot be broken down, or can be broken down to only a limited extent, by the human organism (so-called soluble dietary fibre). Resistant dextrins are produced by a thermal and/or enzymatic treatment of starch wherein, in contrast to the latter, not only 1,1-glycoside and 1,4-glycoside bonds are present but also 1,2-glycoside and 1,3-glycoside ones.

Favourably, the molecules of the resistant dextrin in the sugar confectionery according to the invention are each formed by approximately 8 to approximately 30 glucose units. The resistant dextrin preferably includes Nutriose®, which is available from Roquette (France), in particular the product Nutriose® FB06 (from wheat starch) or FM06 (from maize starch).

Because they are not metabolised by the microorganisms of the bacterial dental plaque, resistant dextrins are not cariogenic either. Moreover, despite the fact that they are only indigestible to a limited extent, they have no laxative effect.

According to the invention, the sugar confectionery based on a gelatin gel includes approximately 1 to approximately 15 weight % of gelatin, wherein this proportion is preferably approximately 5 to approximately 15 weight %, and more preferably approximately 7 to approximately 12 weight %. The gelatin favourably has a Bloom strength in the range of approximately 160 to approximately 300 g Bloom.

According to a further embodiment of the invention, the sugar confectionery further includes a proportion of up to 25 weight % of polydextrose. In this case, the proportion of resistant dextrin may be reduced accordingly. Polydextrose is a synthetic polysaccharide which is made from glucose and sorbitol and in which not only 1,2-, 1,3-, 1,4- but also 1,6-glycoside bonds are present. Unlike resistant dextrin, polydextrose has a moderate laxative effect, and for this reason the proportion of approximately 25 weight % should not be exceeded.

In addition to gelatin, trehalose and resistant dextrin, the sugar confectionery according to the invention may contain further constituents known from the prior art, in particular edible acids, sweeteners, flavourings and/or colourings.

Furthermore, the sugar confectionery according to the invention may also contain one or more sugar alcohols as a supplementary sweetening agent, in particular in a quantity of less than 10 weight %, preferably less than 5 weight %. In these quantities, there is substantially no risk of laxative effect, with the result that there is no need for labelling the product as such in accordance with the legal provisions. A preferred sugar alcohol is in particular xylitol, which is not only tooth-friendly but even has an anti-cariogenic effect (see for example C. Hohmann, Pharmazeutische Zeitung 38 (2007)).

The sugar confectionery according to the invention is preferably selected from the group comprising gumdrops (including jelly bears and jelly babies), marshmallows, chewable sweets and pastilles.

Each of the individual constituents of the sugar confectionery according to the invention is tooth-friendly, something which is also demonstrably the case in the sugar confectionery itself. According to a generally recognised definition which has also been regulated by legal ordinance in Switzerland, a product may be described as tooth-friendly or safe for teeth if the pH value of the bacterial dental plaque does not fall below a boundary value of 5.7 while the product is consumed and within 30 minutes thereafter. This pH value may be measured by means of so-called intraoral plaque-pH telemetry (see T. Imfeld: Identification of Low Caries Risk Dietary Components. Monographs in Oral Science, vol. 11, S. Karger, Basel, 1983). It has been shown that the sugar confectionery according to the present invention meets this condition (see below).

To manufacture the sugar confectionery according to the invention, preferably two aqueous solutions are prepared, with one solution containing gelatin and the other solution containing trehalose and resistant dextrin. Once the two solutions have been combined to form a moulding solution, this is then, at 60 to 90° C., cast into a hollow mould that defines the shape of the sugar confectionery or extruded, wherein, in the case of gumdrops, these hollow moulds are typically formed in a bed of starch powder (Mogul technology).

So that the moulding solution can be processed at sufficient speed using the available machines, its viscosity must not be too high. From this point of view, a moulding solution for manufacturing the sugar confectionery according to the invention has good processing properties.

These and further advantages of the invention will be described in more detail by way of the examples below, with reference to the Figures.

### BRIEF DESCRIPTION OF THE SEVERAL VIEWS OF THE DRAWING(S)

In detail:

FIGS. 1 and 2 show pH telemetry graphs, with the pH value shown as a function of time.

### EXAMPLES

### Manufacture of Gumdrops

As examples of the sugar confectionery according to the invention, gumdrops having two different compositions of the components listed in Table 1 below were manufactured, with the weight proportions indicated in each case.

TABLE 1

| | Example 1 | Example 2 | Example 3 |
|---|---|---|---|
| Components A: | | | |
| Gelatin type A | 8.00 wt % | 8.00 wt % | 8.000 wt % |
| (Bloom 260 g) | | | |
| Water | 16.18 wt % | 14.18 wt % | 14.180 wt % |
| Components B: | | | |
| Trehalose | 26.00 wt % | 10.00 wt % | 10.000 wt % |
| Nutriose ® 06 | 30.00 wt % | 20.00 wt % | 21.000 wt % |
| (resistant dextrin) | | | |
| Polydextrose | 3.00 wt % | 21.32 wt % | 22.320 wt % |
| Xylitol | — | 5.00 wt % | 3.000 wt % |
| Water | 16.00 wt % | 21.00 wt % | 20.988 wt % |
| Components C: | | | |
| Lactic acid (90 wt | 0.64 wt % | — | — |
| % solution) | | | |
| Malic acid | — | 0.50 wt % | 0.500 wt % |
| Sucralose (3 wt % | 0.18 wt % | — | — |
| solution) | | | |
| Sucralose (10 wt | — | — | 0.012 wt % |
| % solution) | | | |

In each case, the components B were mixed, boiled down at 112° C. to a dry substance of approximately 84 weight %, and then cooled to 90° C. The components A were dissolved at 60° C. The components A and C were added to the components B one after the other, and a homogeneous moulding solution was prepared.

To manufacture the gumdrops, the moulding solution was poured into hollow moulds formed in a bed of starch powder, wherein the moulding solution could be readily processed in every respect.

The gumdrops, which were removed from the starch powder after being dried at room temperature for 48 hours, underwent sensory analysis and were found to have a pleasant consistency and texture (elastic and not tacky). In the case of the gumdrops according to Example 1, as a result of the relatively high proportion of trehalose partial crystallisation was observed, which gave a texture similar to that of British jelly babies. In the case of the gumdrops according to Example 2, no crystallisation at all of the trehalose or other constituents occurred, and the texture corresponded to that of jelly bears like those known for example in Germany.

### Demonstration of Tooth-Friendly Properties

The tooth-friendly properties of the gumdrops according to the examples above were tested using intraoral plaque-pH telemetry.

The subjects on whom the tests were performed had a mandibular telemetric prosthesis incorporating a miniaturised glass pH electrode installed in an interproximal area. The prostheses were inserted in a clean condition and the subjects were asked to maintain their normal eating habits for the duration of the test, from 3 to 6 days, but to refrain from all oral hygiene in the mandible. The fact that the prostheses were not removed allowed undisturbed growth of bacterial dental plaque over the membrane surfaces of the interdentally installed electrodes.

During the actual test, each subject consumed a gumdrop, and the pH value during consumption and in the 30 minutes thereafter was detected. In both gumdrops (Examples 1 and 2), it was shown here that the pH value did not fall below the boundary value of 5.7, regardless of the age of the plaque (3, 4, 5 and 6 days).

As a positive control, the subjects then each performed a rinse with a sucrose solution (0.3 mol/litre). In all cases, this resulted in a marked fall in the pH value, to the range between 4 and 5.

Before and after the test, and between the consumption of the gumdrop and the rinsing with sucrose solution, the electrode was neutralised by chewing paraffin.

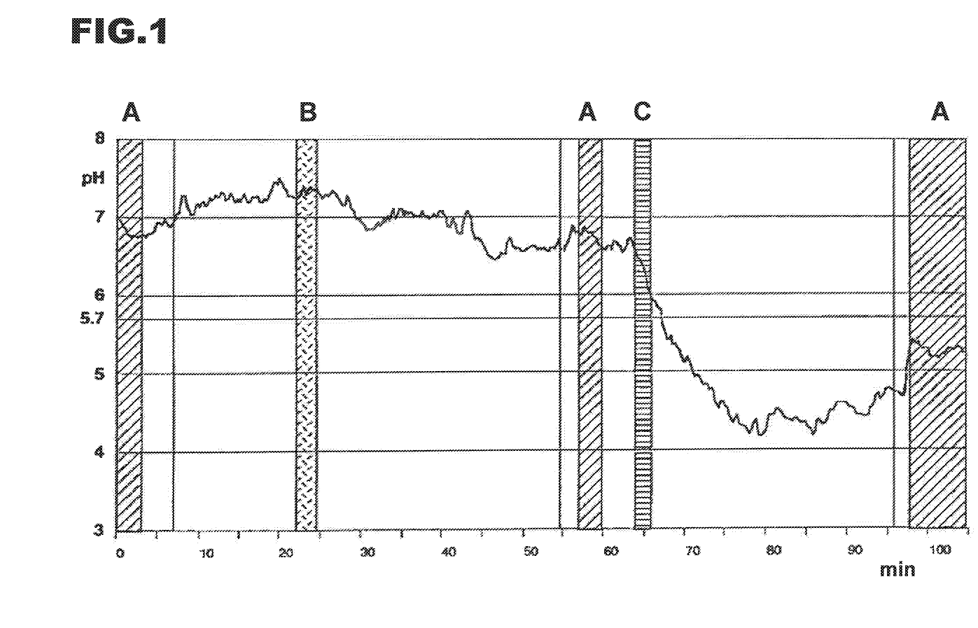

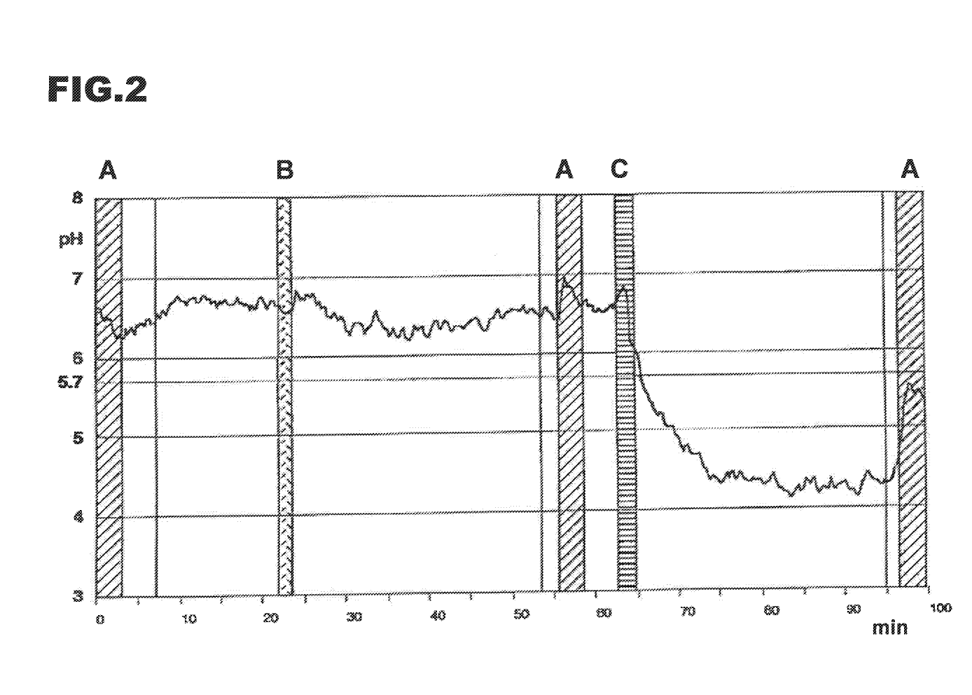

The complete graph for the pH value measured by pH telemetry as a function of time in minutes is shown in FIG. 1 for a gumdrop according to Example 1 with plaque 5 days old, and in FIG. 2 for a gumdrop according to Example 2 with plaque 6 days old. Here, the hatched time periods have the following respective significance:

A: chewing paraffin

B: consumption of the gumdrop

C: rinsing with sucrose solution

The pH telemetry provided unambiguous substantiation of the fact that the sugar confectionery according to the present invention is tooth-friendly.

1. A tooth-friendly sugar confectionery comprising a gelatin gel, which includes approximately 1 to approximately 15 weight % of gelatin, wherein the sugar confectionery includes trehalose and a resistant dextrin.

2. The tooth-friendly sugar confectionery according to claim 1, wherein the proportion of trehalose is in the range of up to approximately 30 weight % of the weight of the confectionary.

3. The tooth-friendly sugar confectionery according to claim 1, wherein, besides trehalose, the sugar confectionery includes less than approximately 10 weight % of mono- or disaccharides.

4. The tooth-friendly sugar confectionery according to claim 3, wherein the sugar confectionery includes no further mono- or disaccharides other than trehalose.

5. The tooth-friendly sugar confectionary according to claim 1, wherein the resistant dextrin is in the range of up to approximately 30 weight % of the weight of the confectionary.

6. The tooth-friendly sugar confectionery according to claim 1, wherein the resistant dextrin comprises molecules each formed by approximately 8 to approximately 30 glucose units.

7. The tooth-friendly sugar confectionery according to claim 1, wherein the resistant dextrin includes Nutriose®.

8. The tooth-friendly sugar confectionery according to claim 1, wherein the sugar confectionery further includes to approximately 25 weight % of polydextrose.

9. The tooth-friendly sugar confectionery according to claim 1, wherein the sugar confectionery further includes one or more of edible acids, sweeteners, flavourings and colourings.

10. The tooth-friendly sugar confectionery according to claim 1, wherein the sugar confectionery further includes one or more sugar alcohols.

11. The tooth-friendly sugar confectionery according to claim 10, wherein the sugar alcohol includes xylitol.

12. The tooth-friendly sugar confectionery according to claim 1, wherein the sugar confectionery is selected from the group comprising gumdrops, marshmallows, chewable sweets and pastilles.

13. The tooth-friendly sugar confectionery according to claim 2, wherein the proportion of trehalose is in the range from approximately 10 to approximately 27 weight %.

14. The tooth-friendly sugar confectionery according to claim 5, wherein the resistant dextrin is in the range from approximately 10 to approximately 26 weight %.

15. The tooth-friendly sugar confectionery according to claim 7, wherein the resistant dextrin includes Nutriose® 06.

16. The tooth-friendly sugar confectionery according to claim 10, wherein the one or more sugar alcohols are included in a quantity of less than 10 weight %.
